(19) United States
(12) Patent Application Publication
(10) Pub. No.: US 2025/0047534 A1
(43) Pub. Date: Feb. 6, 2025

(54) DELAY-DOPPLER DOMAIN CHANNEL ESTIMATION AND FRAME SYNCHRONIZATION

(71) Applicant: NewSouth Innovations Pty Limited, Sydney, New South Wales (AU)

(72) Inventors: Jinhong Yuan, Sydney, New South Wales (AU); Yixuan Xie, Sydney, New South Wales (AU); Cheng Shen, London (GB)

(21) Appl. No.: 18/846,739

(22) PCT Filed: Mar. 13, 2023
(86) PCT No.: PCT/AU2023/050174

§ 371 Date: Sep. 13, 2024

(30) Foreign Application Priority Data
Mar. 14, 2022 (AU) 2022900617

(51) Int. Cl. H04L 27/14

(52) U.S. Cl. CPC H04L 27/14

(57) ABSTRACT

The present disclosure provides a wireless receiver having a Delay Doppler channel detector. The Delay Doppler channel detector includes a Delay Dopper domain channel estimator and a detector and demodulator. The Delay Doppler domain channel estimator is configured for estimating a channel gain, a delay, and a Doppler frequency shift of a path of a channel of data received via the channel. The detector and demodulator is configured for extracting a symbol sequence of the received data based on the estimated channel gain, the estimated delay, and the estimated Doppler frequency shift of the path of the channel.

### TECHNICAL FIELD

The present invention relates generally to a communication system and, in particular, to using Delay-Doppler domain channel estimation and frame synchronization in a wireless communication.

### BACKGROUND

Communication is the process of conveying information from a transmitter to a receiver through a channel. The transmitter generates a signal containing the information to be sent. The signal propagates to the receiver, incurring various types of distortions caused by what is called the channel (e.g., liquid, cable, air, etc.). The most well-known distortions are channel fading, time dispersion due to delay, frequency dispersion due to Doppler, carrier frequency offset, symbol timing offset, and additive noise. The receiver then observes the distorted signal and attempts to recover the transmitted information with the help of side information that relate to the transmitted signal or the nature of the channel. The more side information the receiver has, the better the chance it can do at recovering the unknown information.

In nowadays, digital communication is replacing analog communication in almost every new application, due to that it is fundamentally suitable for transmitting digital data such as data found on every computer, cellular phone, and all other smart devices. Also, digital communication systems offer higher quality, increased security, better robustness to noise, less power usage, and easy system integration of different sources. Digital communication devices take advantage of the reductions in cost and size as majority of the digital components are implemented using integrated circuits. Although most of the digital communication systems still perform majority of the processing using application-specific integrated circuits (ASICs) and field programmable gate arrays (FPGAs), digital communication systems are also very easy to reconfigure using the concept of software-defined radio (SDR). Digital communication is now a fundamental part of modern communication systems and will continuously play the key role in the future generations of communication systems.

Radar and Sonar signal processing also apply the similar signal processing technologies to utilise the channel impairments such as delay and Doppler to estimate the target distance and moving speed/directions.

Communications systems and Radar (Sonar) sensing systems share many hardware and signal processing units, such as RF transmission and receiving units, waveform generator, channel delay/distance and Doppler/speed estimation, etc. There is an increasing trend to design Integrated Communication and Sensing (ICAS) or joint communications radar sensing (JCR) technology which integrates both systems into one by sharing common hardware signal processing algorithms, and spectrum. ICAS can achieve immediate benefits of reduced cost, size, power, and improved spectral efficiency. It also allows communications and Radar sensing to exchange side-information, leading to improved performance. Therefore, this innovation can be applied to both communications and Radar sensing or ICAS systems.

In some high-speed V2X systems such as high-speed railways, highway cars, bullet-trains, low-earth orbit (LEO) satellite systems, and underwater acoustic communications, radio frequency waves are highly time and frequency dispersed because of the effect of Doppler and the delay of signals. The quality of these communication systems significantly affected, as the time and frequency dispersion will significantly affect the reliability and the data rate are significantly reduced. This invention focuses on providing a solution to overcome this problem by designing a new transmission method and receiving methods in single carrier modes to effectively and efficiently 1) perform the frame synchronization to the recover of the transmitted signal frame; 2) estimate the channel, including each propagation path's amplitude response, delay shift and Doppler shift and detect the transmitted signals. The transmitted signal frame and format are carefully designed such that the frame synchronization and channel estimation can be obtained in a simple manner in the delay-Doppler domain. They are crucial for the receiver to compensate for the effects of dispersions caused by the Doppler effects and signal delays, and then detection the transmitted signal with simple detectors or equalizers accurately with lower or comparable computational complexity to the prior art approaches.

FIG. 1 shows a conventional arrangement of a communication system 100. The communication system 100 has a transmitter 110, a channel 130, and a receiver 120.

The transmitter 110 comprises a source 112, a source encoder 114, a channel encoder 116, and a modulator 118. The source 112 is a digital sampler for sampling analog data and generating corresponding digital data. The digital data generated by the source 112 is in the form of a binary sequence {b[n]}=b[0], b[1], . . . . The binary sequence {b[n]} is then provided to the source encoder 114.

The source encoder 114 transforms the received binary sequence {b[n]} into an information sequence {i[n]} that uses as few bits per unit time as possible. The source encoder 114 therefore compresses the binary sequence {b[n]} while reducing possible information loss. The information sequence {i[n]} is then provided to the channel encoder 116.

The channel encoder 116 is also known as the error control coding block. The channel encoder 116 adds redundancy to the information sequence {i[n]} to produce a coded sequence {c[n]}. The coded sequence {c[n]} provides resilience to channel distortion and increases the chance of successfully recovering any lost information at the receiver 120. The information sequence {i[n]} is typically divided into blocks of size k bits. The channel encoder 116 adds r redundancy bits to each block, resulting in each coded block having m bits where m=k+r and the coding rate is k/m. The addition of redundancy bits enables errors to be detected and corrected at the receiver 120 so that the receiver 120 can either discard the data in error or request a retransmission. The coded sequence {c[n]} is provided to the modulator 118.

The modulator 118 maps the coded sequence {c[n]} into signal constellations. Typically, the bits in the coded sequence {c[n]} are mapped in groups to symbols {u[n]}. The modulator 118 then converts the symbols {u[n]} into analog signals x (t) for transmission over the channel 130. The conversion of the symbols {u[n]} into analog signals x (t) includes converting digital symbols {u[n]} into a pulse train, filtering the pulse train using a pulse shaping filter, such as root Raised Cosine filter, Gaussian filter, and mixing the filtered signal onto a higher-frequency carrier. The period for the symbols {u[n]} is Tₛ=1/Rₛ, where Rₛ is the symbol rate.

The analog signals x(t) then travels to the receiver 120 via the channel 130. The channel 130 may be air, a wire, water, and the like. The channel 130 introduces losses to the analog signals x(t) due to reflection, diffraction, and scattering.

The analog signals y(t) is the analog signals x(t) that have travelled through the channel 130. The receiver 120 receives the analog signals y(t).

The receiver 120 comprises a demodulator 122, a channel decoder 124, a source decoder 126, and a sink 128. The demodulator 122 receives the analog signals y(t). The demodulator 122 includes a carrier de-mixer, a matched filter (not shown) and a symbol synchronizer. The carrier de-mixer removes the higher frequency carrier, and the matched filter reverse the processes carried out by the pulse shaping filter of the modulator 118. Symbol synchronization works together with the matched filter to find the maximum output signal-to-noise ratio (SNR). The output of the matched filter and symbol synchronizer is sampled at the rate of Rₛ=1/Tₛ. The result of this process is a sampled sequence {ŝ[n]}.

The demodulator 122 uses the sampled sequence {s[n]} to infer the transmitted symbols {s[n]}. The inference process includes symbol and frame detection, channel estimation, frequency offset correction, data detection, or other advanced algorithms to combat the effect of channel distortions. After performing a sequence of sophisticated algorithms, the sampled sequence {ŝ[n]} is then de-mapped into bit sequences {ĉ[n]}, which are used to perform a best guest of the transmitted bits, or to provide tentative decisions as the input to the channel decoder 124.

The channel decoder 124 receives and processes the bit sequences {ĉ[n]} to detect the existence of any error and produces the best possible guess of the information sequence {î[n]}. The channel decoder 124 performs error detection by using the r redundancy bits (see the discussion above relating to the channel encoder 116) and a decoding algorithm to remove errors (due to noise and distortion introduced in the channel 130). The information sequence {î[n]} is then provided to the source decoder 126. In an iterative receiver, the output of the channel decoder 124 is fed back to the demodulator 122 to further improve the accuracy of demodulator output.

The source decoder 126 processes the information sequence {î[n]} to generate binary data {\hat{b}[n]}. If no further error exists, then the binary data is equated with the binary sequence (i.e., {\hat{b}[n]}={b[n]}). The transmission is then complete. However, if the error cannot be corrected, a retransmission may be required. The binary sequence {\hat{b}[n]} is then provided to the sink 128. The sink 128 is a device such as a computer to display a video (if the binary sequence {b[n]} relates to a video).

### SUMMARY

There is a need to improve wireless communication to better overcome the dispersion effects of Doppler and signal delays in the channel 130. Wireless communication refers to any communication without a fixed line, such as communication using electromagnetic signals, communication using acoustic signals, and the like. Wireless communication also refers to receiving signals for a sensing system (e.g., radar system).

According to a first aspect of the present disclosure, there is provided a wireless receiver comprising: a Delay Doppler channel detector comprising: a Delay Doppler domain channel estimator configured for estimating a channel gain, a delay, and a Doppler frequency shift of a path of a channel of data received via the channel; and a detector and demodulator configured for extracting a symbol sequence of the received data based on the estimated channel gain, the estimated delay, and the estimated Doppler frequency shift of the path of the channel.

According to another aspect of the present disclosure, there is provided a method of receiving wireless communication, the method comprising: estimating a channel gain, a delay, and a Doppler frequency shift of a path of a channel of data received via the channel; and extracting a symbol sequence of the received data based on the estimated channel gain, the estimated delay, and the estimated Doppler frequency shift of the path of the channel.

According to another aspect of the present disclosure, there is provided a wireless transmitter comprising: a pilot and data multiplexer configured for inserting a prefix zero padded sequence, a pilot symbol of a sequence of pilot symbols, and a suffix zero padded sequence into a time slot of a frame of data to be transmitted.

According to another aspect of the present disclosure, there is provided a computer program product including a computer readable medium having recorded thereon a computer program for implementing the method described above.

According to another aspect of the present disclosure, there is provided a wireless transmitter comprising: a pilot and data multiplexer configured for inserting a prefix zero padded sequence, a pilot symbol of a sequence of pilot symbols, and a suffix zero padded sequence into a time slot of a frame of data to be transmitted.

Other aspects are also disclosed.

### BRIEF DESCRIPTION OF THE DRAWINGS

Some aspects of the prior art and at least one embodiment of the present invention will now be described with reference to the drawings and appendices, in which:

FIG. 1 shows a general arrangement for a communication system;

FIG. 2 is a communication system according to the present disclosure;

FIG. 3A is a Delay-Doppler Channel detector of the communication system of FIG. 2;

FIG. 3B is a block diagram of a frame synchronizer of the Delay-Doppler Channel detector of FIG. 3A;

FIGS. 4A and 4B form a schematic block diagram of a general purpose computer system upon which the transmitter or the receiver of the communication system of FIG. 2 can be practiced;

FIG. 5 shows an example of time (delay) to frequency (Doppler) conversion for an N-point discrete Fourier transform;

FIG. 6 is an example of pilot symbol insertion into the data blocks;

FIG. 7 is a flow chart of a method performed by the Delay-Doppler Channel detector of FIG. 3A;

FIG. 8 is a flow chart of a method performed by a frame synchronizer of the Delay-Doppler Channel detector of FIG. 3B.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which form public knowledge through their respective publication and/or use. Such should not be interpreted as a representation by the present inventor(s) or the patent applicant that such documents or devices in any way form part of the common general knowledge in the art.

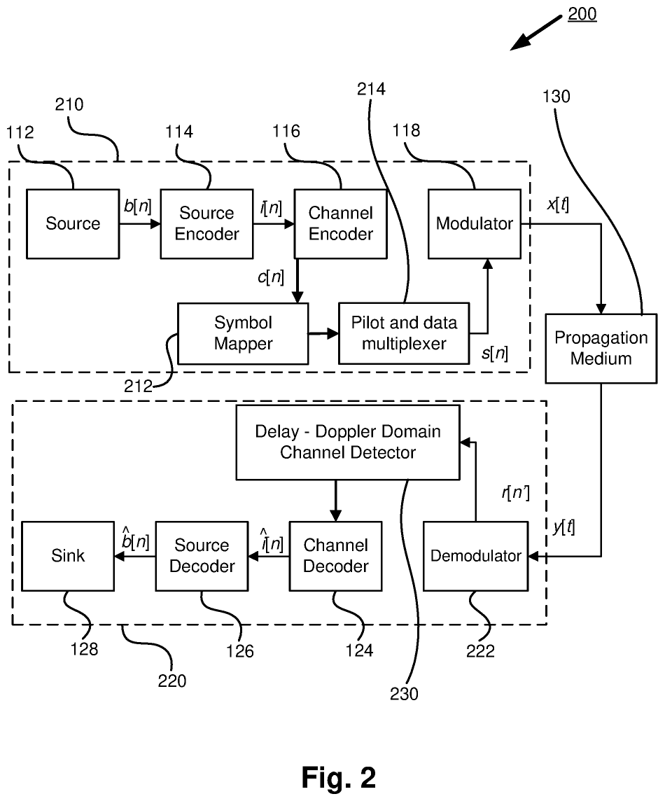

FIG. 2 shows a communication system 200 having a transmitter 210, a receiver 220, and a channel 130.

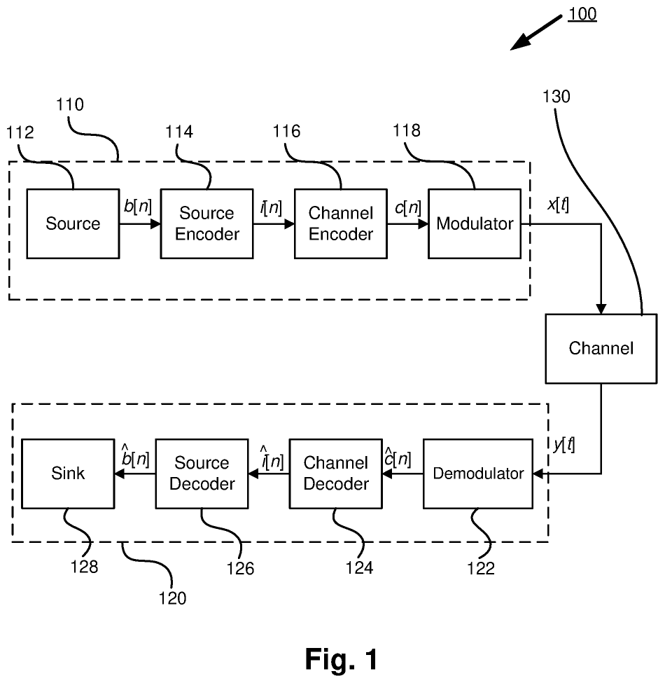

The transmitter 210 comprises a source 112, a source encoder 114, a channel encoder 116, a symbol mapper 212, a pilot and data multiplexer 214, and a modulator 118. The source 112 is the same as the source 112 in the communication system 100 of FIG. 1. In the example provided, the source 112 generates an A-bit binary sequence {b[n]}=b[0], b[1], . . . , b[A−1]. The binary sequence {b[n]} is then provided to the source encoder 114.

The source encoder 114 is the same as the source encoder 114 in the communication system 100 of FIG. 1. The source encoder 114 receives the A-bit binary sequence {b[n]} and generates an information sequence {i[n]}=i[0], i[1], . . . , i[B−1] of length B, where B<A, meaning that a smaller number of bits need to be sent for a receiver to fully recover {b[n]}. The information sequence {i[n]} is then provided to the channel encoder 116.

The channel encoder 116 is the same as the channel encoder 116 in the communication system 100 of FIG. 1. The channel encoder 116 receives the information sequence {i[n]} and adds P redundant bits, resulting in a sequence of coded bits {c[n]} of length D=(B+P). The overall coding rate is equal to B/D. The higher the coding rate, the higher the spectrum efficiency, but a higher coding rate would result in less error correction capability at the receiver 220. The sequence of coded bits {c[n]} is provided to the symbol mapper 212.

The symbol mapper 212 receives and maps the coded bits {c[n]} in groups to a sequence of symbols {u[n]}. The symbol sequence {u[n]} is then segmented to N time slots, where each time slot has M′ symbols. A frame is formed by N time slots. That is, {u[n]}={{u₀[n]}, {u₁[n]}, {u₂[n]}, . . . , {u_{N-1}[n]}}, where {uᵢ[n]} is a segment of M′ symbols for time slot i. The symbol sequence {u[n]} is provided to the pilot and data multiplexer 214.

The pilot and data multiplexer 214 receives the sequence of symbols {u[n]} and adds a pilot signal using a process called pilot data multiplexing. The pilot signal {tᵢ[n]} has a length of Np for time slot i. The addition of the pilot signal {tᵢ[n]} to a segment of the symbol sequence {u[n]} results in a combined sequence {sᵢ[n]}. The combined sequence {sᵢ[n]}=[{tᵢ[n]}, {uᵢ[n]}] for the i-th time slot has a length of M=M′+Nₚ, where M′ denotes the length of each segment of symbols sequence {uᵢ[n]}. The pilot signals {tᵢ[n]}, i=0,1,2, . . . , N−1, are generated from a pilot sequence {T[n]} in a distributed manner. In one arrangement, a pilot symbol together with a prefix zero-padded sequence (i.e., before the pilot symbol) and a suffix zero padded sequence (i.e., after the pilot symbol) form a pilot signal that is added to each time slot. In an alternative arrangement, a prefix zero padded sequence, a pilot symbol, and a suffix zero padded sequence form a pilot signal that is added only to certain time slots. For example, a pilot signal is added for every 2, 3, or more time slots, and only zero-padded sequences are added for other time slots. In other words, certain time slots do not have any pilot symbols. The addition of pilot signals into the symbol sequence {u[n]} is dependent on the Doppler frequency shift of the channel 130.

The pilot symbol can be chosen from a well-defined pilot sequence {T[n]} of any one of the following, or similar with good correlation properties:
1. Zadoff-Chu sequence of length 16 pilot symbols:

$$[ 1 , {e}^{j \frac{3 π}{16}} , {e}^{j \frac{3 π}{4}} , {e}^{- j \frac{5 π}{16}} , - 1 , {e}^{j \frac{11 }{16}} , {e}^{j \frac{3 π}{4}} , {e}^{- j \frac{3 π}{16}} , 1 , {e}^{- j \frac{3 π}{16}} , {e}^{j \frac{3 π}{4}} , {e}^{j \frac{11 π}{16}} , - 1 , {e}^{- j \frac{5 π}{16}} , {e}^{j \frac{3 π}{4}} , {e}^{j \frac{3 π}{16}} ] \qquad ( a )$$

2. Frank sequence of length 16 pilot symbols:

[1,1,1,1,1,−j,−1,j,1,−1,1,−1,1,j,−1,−j]. (b)
3. Golay complementary sequence of length 24 pilot symbols:

[−1,1,1,1,1,−1,1,1,−1,1,1,1,1,−1,1,1,1,−1,−1,−1,1,−1,1,1]. (c)
4. Barker sequence of length 11 pilot symbols:

[−1,−1,−1,1,1,1,−1,1,1,−1,1]. (d)

Other sequences that can be used are as follows: Gold sequence, Hadamard sequence, Legendre sequence and Maximum length sequence (M-sequence), JPL sequence, Kasami sequence, polyphase sequence, general complementary sequence.

In an alternative arrangement, the Inverse Discrete Fourier Transform (IDFT) of the above pilot sequence is used.

For example, if the Zadoff-Chu sequence of 16 pilot symbols is used and a pilot signal is inserted to every time slot, then the pilot signal insertion is as follows: pilot symbol 1 (T[1]) is added to the first time slot, pilot symbol

$${e}^{j \frac{3 π}{16}} ( T [ 2 ] )$$

is added to the second time slot, and so on. As discussed above, zero-padded sequences may be added to each of the pilot symbols of the Zadoff-Chu sequence.

In another example, if the Zadoff-Chu sequence of 16 pilot symbols is used and a pilot signal is inserted to every second time slot, then the pilot signal insertion is as follows: pilot symbol 1 (T[1]) is added to the first time slot, pilot symbol

$${e}^{j \frac{3 π}{16}} ( T [ 2 ] )$$

is added to the third time slot, and so on. As discussed above, zero-padded sequences may be added to each of the pilot symbols of the Zadoff-Chu sequence or zero-padded sequences are added to the second time slot and other time slots without the Zadoff-Chu sequence pilot symbol.

As discussed, the pilot signal {tᵢ[n]} has a length of Nₚ for time slot i. The length Nₚ=2F+1, where F≥L+1, where L is the length of channel's maximum delay spread in the number of samples. To reduce the overhead in the transmission data, F is set to be L+1. The pilot signal {tᵢ[n]} therefore is a sequence {tᵢ[n]}=[tᵢ[0], tᵢ[1], . . . , tᵢ[Nₚ−1]]=[ [symbol] _{F} tᵢ[F] [symbol] _{F}], where tᵢ[F]=T[i] is a pilot symbol chosen from {T[n]}, and [symbol] _{F} is an all-zero vector with length F. The vector length of [symbol] _{F} is determined by the maximum channel delay spread τ_{d}, whereas the Doppler frequency of the channel 130 determines the frequency of insertion of the pilot sequence into the frames. In one arrangement where a pilot symbol is not inserted into the pilot signal {tᵢ[n]}, then the length Np is dependent on the number of zero-padded sequences inserted into the pilot signal {tᵢ[n]}. For example, Nₚ=F, if one zero-padded sequence is inserted into the pilot signal {tᵢ[n]}, and more data symbols can be multiplexed in the time slot.

The all-zero vector [symbol] _{F} is equivalent to zero-padding the sequence of symbols {uᵢ[n]}, as the combined sequence {sᵢ[n]}=[{tᵢ[n]}, {uᵢ[n]}] for each time slot. Therefore, the pilot signal {tᵢ[n]} serves three purposes, namely (1) as a zero-padded cyclic prefix (CP); (2) as a pilot for channel estimation; and (3) as a training sequence for frame synchronization.

The sequence of symbols {u[n]}={{u₀[n]}, {u₁[n]}, {u₂[n]}, . . . , {u_{N-1}[n]}}, where N is the number of time slots, and each time slot has the length of M′. As mentioned above, the insertion of the pilot symbols of the pilot signal {tᵢ[n]} is dependent on the Doppler frequency shift. The Doppler frequency shift is given by

$$v = \frac{1}{2 qT} ,$$

where 1≤q≤N/2, and T is the duration of a time slot.

$$The structure of the combined sequence is \{ s [ n ] \} = \{ \{ {s}_{0} [ n ] \} , \{ {s}_{1} [ n ] \} , … , \{ {s}_{N - 2} [ n ] \} , \{ {s}_{N - 1} [ n ] \} \} where \{ {s}_{i} [ n ] \} = [ {t}_{i} , [ 0 ] , {t}_{i} [ {N}_{p} - 1 ] , {u}_{i} [ 0 ] , {u}_{i} [ 1 ] , … , {u}_{i} [ {M}^{′} - 1 ] ] = [ {F}_{} , {t}_{i} [ F ] , {F}_{} , {u}_{i} [ 0 ] , {u}_{i} [ 1 ] , … [ {M}^{′} - 1 ] ] for i = 0 , q , 2 q … , ( ⌈ \frac{N}{q} ⌉ - 1 ) q$$

$$and$$

$$\{ {s}_{i} [ n ] \} = [ {W}_{} , {u}_{i} [ 0 ] , {u}_{i} [ 1 ] , … , {u}_{i} [ {M}^{′} - 1 ] for i = elsewhere .$$

where F≤W≤2F+1. In one example, W=2F+1 to make the time slot has a length M=M′+Nₚ.

Accordingly, once the Doppler frequency shift of the channel 130 is determined, then q can be determined. The value of q determines the minimum frequency of pilot symbol insertion into the frames. Accordingly, if q is determined to be n, then a pilot symbol can be inserted every n time slots or every (less than n) time slots.

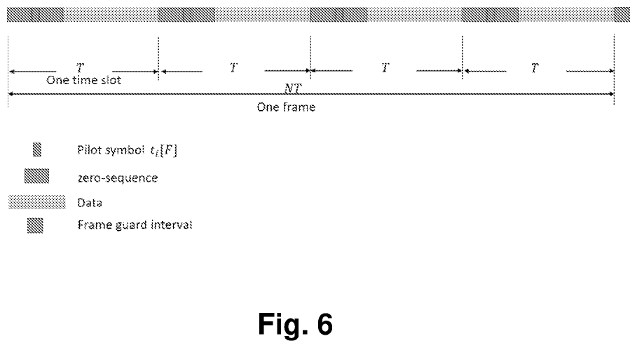

For example, when q=1, then a pilot symbol is inserted into each time slot where the number of data symbols transmitted per slot is M−Nₚ, and the channel estimation overhead is (Nₚ)/M. FIG. 6 shows an example of a pilot symbol being inserted into each time slot.

When q=2, then the minimum frequency of inserting a pilot symbol is every 2 slots where the number of data symbols transmitted per two time slots is 2M−2F−1−W, and the channel estimation overhead is (2F+1+W)/2M.

Similarly, if q=5, then the minimum frequency of inserting a pilot symbol is every 5 slots or every (less than 5) slot.

From the above equation on the combined sequence {s[n]}, it is shown that the all-zero vector [symbol] is inserted into every time slot, regardless of whether a pilot symbol of the pilot sequence {T[n]} is inserted. The insertion of the all-zero vector [symbol] into all time slots is performed because the delay dispersions of symbols in the previous data block may still exist due to the multiple channel paths of the channel 130. Hence, the all-zero vector [symbol] is required to minimize the inter-block interference.

In another arrangement, the pilot and data multiplexer 214 further adds one or more pilot symbols—which are chosen from cyclic shifts of the pilot sequence used above {T[n]}—to the symbol sequence {u[n]}. One additional pilot signal result in a combined sequence {sᵢ[n]}=[{tᵢ[n]}, {uᵢ[n]}] where
{tᵢ[n]}=[ [symbol] _{F}, tᵢ[F], tᵢ[F+1], [symbol] _{F},] and tᵢ[F+1] denotes one additional pilot signal. Two additional pilot signals result in a combined sequence {sᵢ[n]}=[{tᵢ[n]}, {uᵢ[n]}] where
{tᵢ[n]}=[ [symbol] _{F}, tᵢ[F], tᵢ[F+1], tᵢ[F+2], [symbol] _{F}] and tᵢ[F+1] and tᵢ[F+2] denote the two additional pilot signals.

The additional one or more pilot signals are based on the same pilot sequence used above {T[n]}. However, these additional one or more pilot signals are cyclically shifted version of {T[n]}. For example, if the base pilot signal is obtained from the Zadoff-Chu sequence, then the additional pilot signals are cyclic shift variants of the Zadoff-Chu sequence. Let {T^{(s)}[n]} be s-th cyclic shifted version of {T[n]}. We have tᵢ[F]=T[i] is a pilot symbol chosen from {T[n]}, tᵢ[F+1]=T⁽¹⁾[i] is a pilot symbol chosen from {T⁽¹⁾[n]}, and tᵢ[F+2]=T⁽²⁾[i] is a pilot symbol chosen from {T⁽²⁾[n]}.

A pilot signal sequence has a length of zero autocorrelation zone L_{ZACZ} and a length of zero cross-correlation zone L_{ZCCZ}. For an interference-free construction, both L_{ZACZ} and L_{ZCCZ} have the following properties:

L_{ZACZ}≥Kₘₐₓ

L_{ZCCZ}≥2kₘₐₓ

Where kₘₐₓ is maximum Doppler indicator, which can be determined by v/NT.

The cyclically shifted pilot signals to be used must belong in a family of sequences called zero correlation zone (ZCZ) sequence, which have the length of zero auto-correlation zone given by:

$${L}_{ZCZ} = {L}_{ZACZ} = {L}_{ZCCZ} \geq 2 {k}_{max}$$

The family of sequence (i.e., the base pilot signal and its cyclically shifted variants) must satisfy the Tang-Fan-Matsufuji bound, given by: S_{ZCZ}(L_{ZCZ}+1)≤Nₛ, where

$${N}_{s} = ⌈ \frac{N}{q} ⌉$$

is the size or length of each sequence, and S_{ZCZ} is the number of sequences in the family set. The s-th cyclic shifted version of {T[n]} is obtained as
{T^{(s)}[n]}=circ ({T[n]}, sL_{ZCZ}), where s=0, 1, . . . . S_{ZCZ}−1, {T[n]} is cyclically shifted by SL_{ZCZ} positions to obtain {T^{(s)}[n]}.

If the Inverse Discrete Fourier Transform (IDFT) of the above pilot sequence is used, we have
{\hat{T}^{(s′)}[n]}=IDFT ({T^{(s)}[n]}), s′=mod (s, S_{ZCZ}). In this case, \hat{T}^{(s′)}[n] is used as the s-th pilot sequence.

The structure of the combined sequence for one additional pilot signal is {s[n]}={{s₀[n]}, {s₁[n]}, . . . , {S_{N-2}[n]}, {S_{N-1}[n]}} where

$$\{ {s}_{i} [ n ] \} = [ {F}_{} , {t}_{i} [ F ] , {t}_{i} [ F + 1 ] , {F}_{} , {u}_{i} [ 0 ] , {u}_{i} [ 1 ] , … , {u}_{i} [ {M}^{′} - 1 ] ] for i = 0 , q , 2 q … , ( ⌈ \frac{N}{q} ⌉ - 1 ) q$$

and the number of data symbols transmitted in each of these time slots is M−2F−2,
and
{sᵢ[n]}=[ [symbol] _{W}, uᵢ[0], uᵢ[1], . . . , uᵢ[M′−1]] for i=elsewhere and W=2F+2 in this case

The combined sequence {s[n]} is then provided to the modulator 118.

The modulator 118 receives and converts the combined sequence {s[n]} into analog signals x(t) for transmission over the channel 130. The conversion of the combined sequence {s[n]} into analog signals x(t) includes converting digital symbols {s[n]} into a pulse train, filtering the pulse train using a pulse shaping filter, such as root Raised Cosine filter, Gaussian filter, and mixing the filtered signal onto a higher-frequency carrier. The period for the symbols {s[n]} is Tₛ=1/Rₛ, where Rₛ is the symbols rate.

The analog signals x(t) then travels to the receiver 220 via the channel 130. The channel 130 may be air, water, and the like. The channel 130 introduces losses to the analog signals x(t) due to reflection, diffraction, and scattering.

The analog signals y(t) is the analog signals x(t) that have travelled through the channel 130. The receiver 220 receives the analog signals y(t).

The receiver 220 comprises a demodulator 222, a Delay-Doppler Domain Channel Detector 230, a channel decoder 124, a source decoder 126, and a sink 128. The demodulator 222 is similar to the demodulator 122 in the communication system 100 of FIG. 1. The demodulator 222 however does not perform symbol and frame detection, channel estimation, frequency offset correction, data detection, or other advanced algorithms to combat the effect of channel distortions. The function of reducing channel distortions is performed by the Delay-Doppler Channel detector 230.

The demodulator 222 includes a carrier de-mixer, a matched filter (not shown) and a symbol synchronizer. The carrier de-mixer removes the higher frequency carrier. The matched filter reverse the processes carried out by the pulse shaping filter of the modulator 118. If a root Raised Cosine filter is used at the transmitter 210, then the same root raised cosine filter should be used at the receiver 220 as the matched filter to maximize the SNR and remove the inter-symbol interference (ISI). Symbol synchronization works together with the matched filter to find the maximum output signal-to-noise ratio (SNR). The output of the matched filter and symbol synchronizer is sampled at the rate of Rₛ=1/Tₛ. The output of the demodulator 222 is a sampled sequence {r[n′]}, which is provided to the Delay-Doppler Domain Channel Detector 230.

As described in relation to the pilot and data multiplexer 214, there are two possible pilot symbol insertions. The first pilot symbol insertion is when q=1 and a pilot symbol is inserted into each time slot. The second pilot symbol insertion is when q is other than 1 (i.e., q=2 to N/2) and a pilot symbol is inserted into every 2, 3, or more time slots. Accordingly, the detector 230 is implemented dependent on which pilot insertion method is implemented.

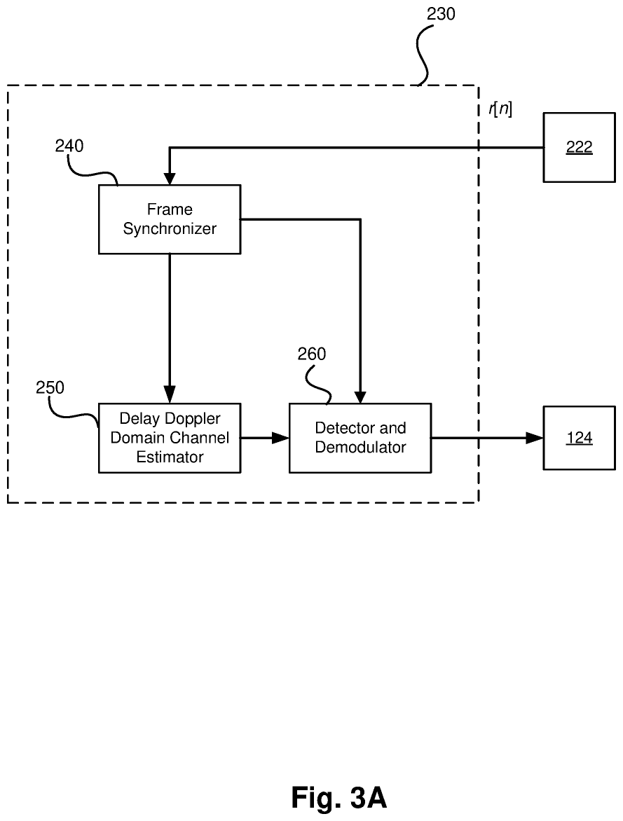

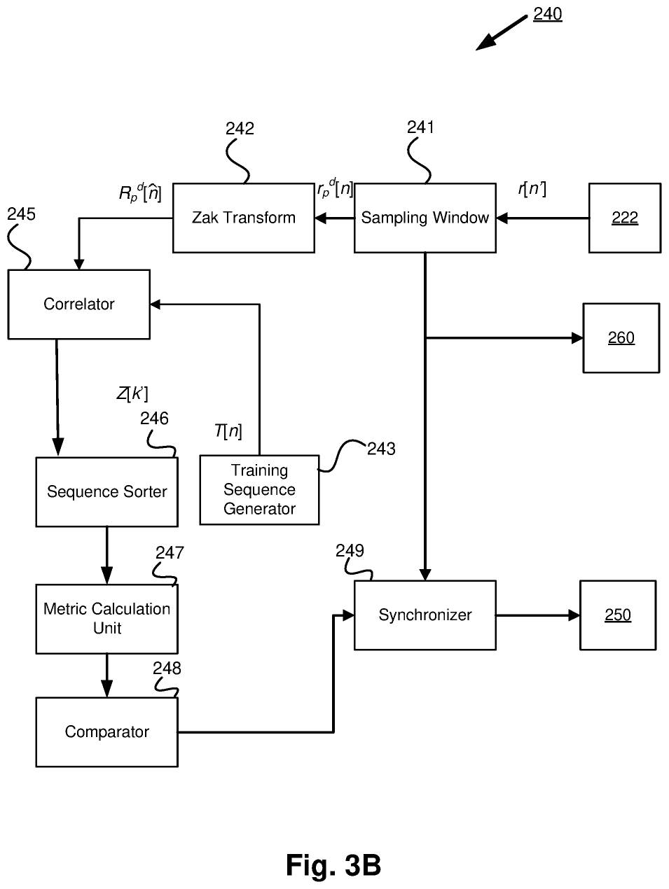

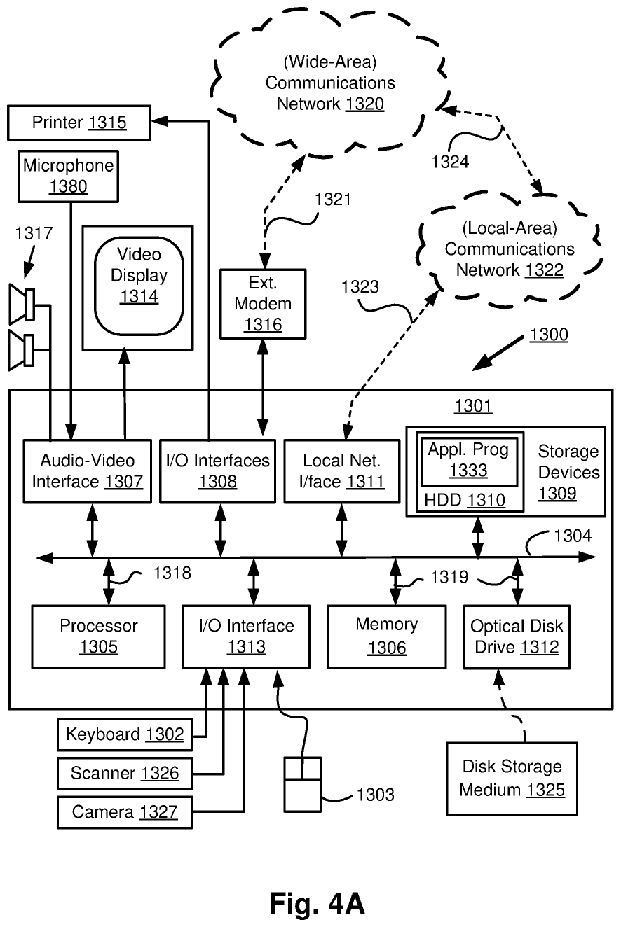

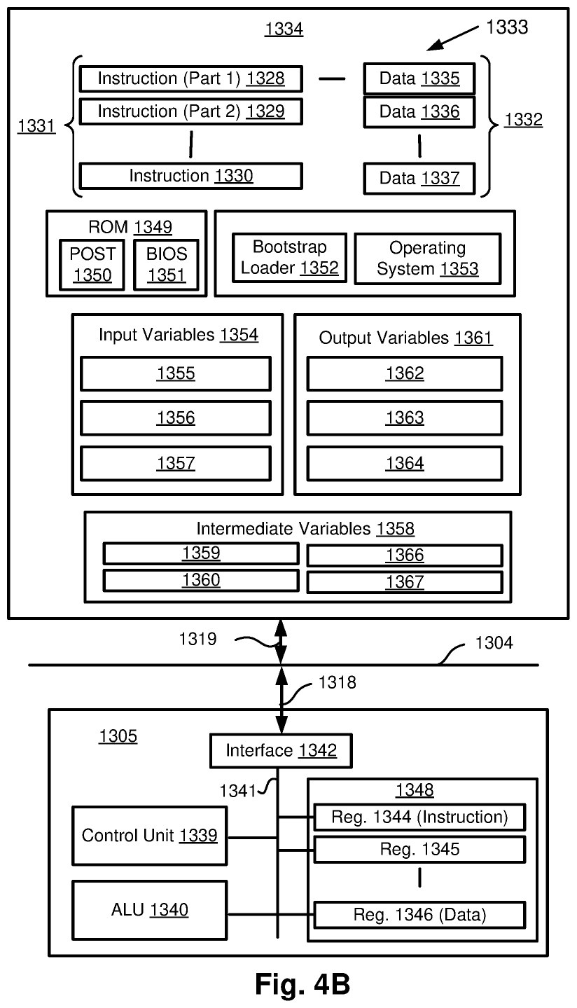

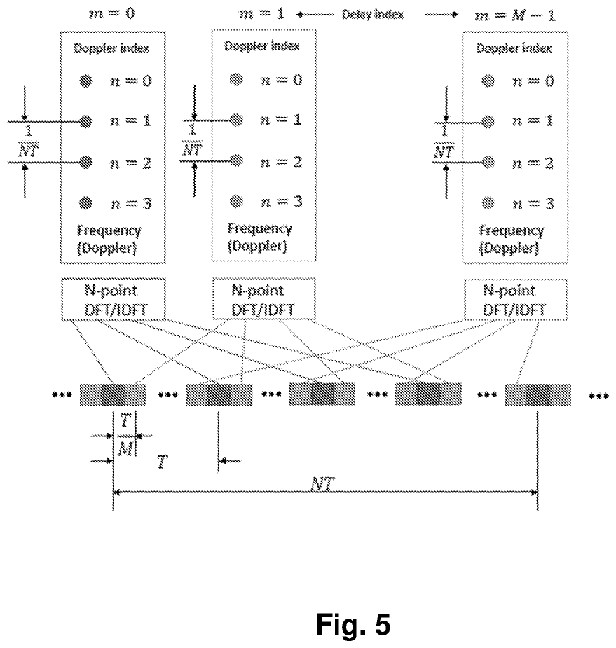

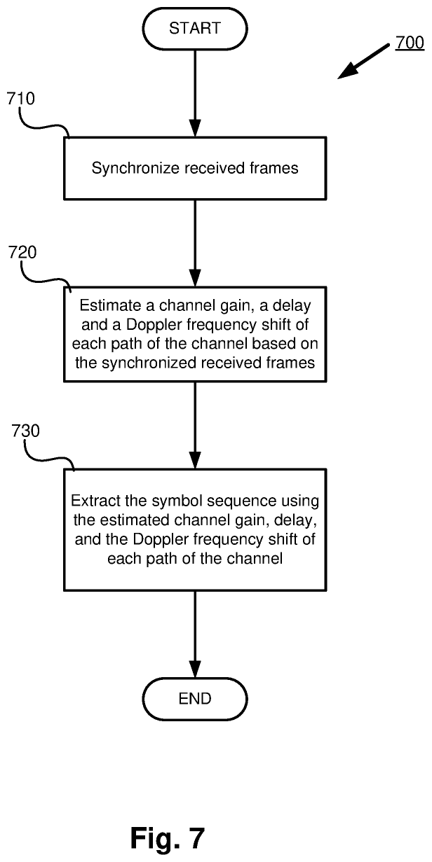

FIG. 3A shows a block diagram of the Delay-Doppler Channel detector 230. The detector 230 includes a frame synchronizer 240, a Delay Doppler Domain channel estimator 250, and a detector and demodulator 260. The operation of the detector 230 is in accordance with method 700 as shown in FIG. 7. In one arrangement, the method 700 is implemented as a computer program that is executed by the computer system 1300 (discussed hereinafter in relation to FIGS. 4A and 4B).

Referring to FIGS. 3A and 7, the detector 230 receives the sampled sequence r[n′] from the demodulator 222 at the frame synchronizer 240. The frame synchronizer 240 then performs frame synchronization (as indicated as the first step 710 of method 700) to align a sampling window to a frame of the sampled sequence r[n′]. In one arrangement, the alignment of the sampling window to the frame is performed by determining the correct starting position of each frame.

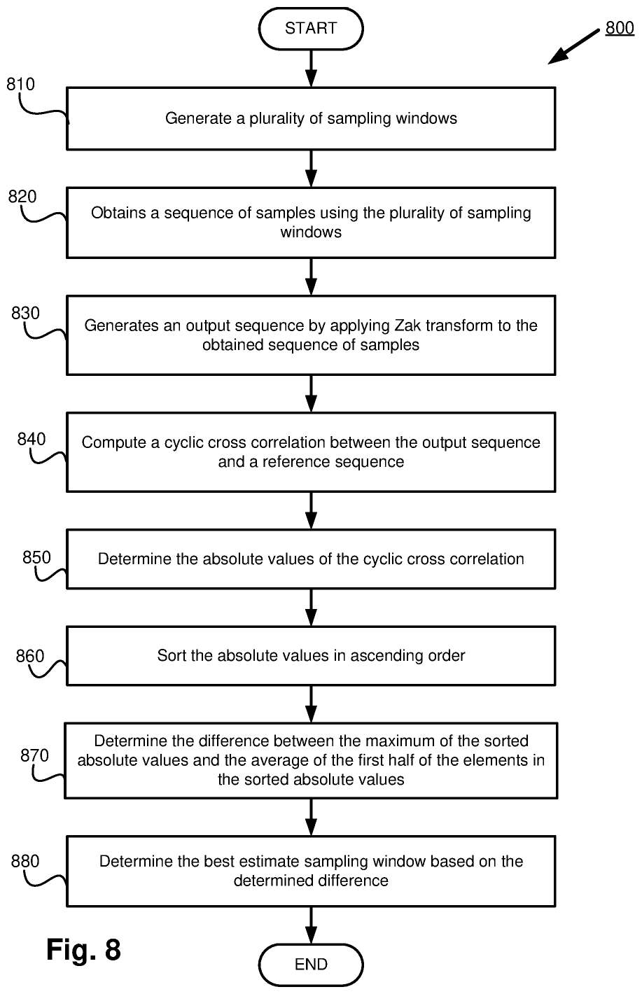

In one arrangement, in order to detect a frame correctly, the correct starting position of each frame must first be determined. To do so, the frame synchronizer 240 generates a plurality of sampling windows, where a sampling window is offset by one sampling position from the immediately preceding sampling window. The sampling position refers to the position of the discrete symbols in the sampled sequence r[n′]. The sampling windows are then compared against a sequence of reference pilot symbols. The sampling window with the least difference to the sequence of reference pilot symbols or with the highest correlation with the sequence of reference pilot symbols is then selected as the sampling window to be used by the detector 230. FIG. 8 shows a method 800 for frame synchronization in accordance with this arrangement.

Although one arrangement has been described, there are other possible arrangements to align a sampling window to a frame.

FIG. 3B shows a block diagram of the frame synchronizer 240 implementing the above discussed arrangement. FIG. 8 shows the method 800 being performed by the frame synchronizer 240 shown in FIG. 3B. The frame synchronizer 240 includes a sampling window 241, a Zak Transform 242, a training sequence generator 243, a correlator 245, a sequence sorter 246, a metric calculation unit 247, a comparator 248, and a synchronizer 249.

The synchronizer 240 receives the sampled sequence r[n′], from the demodulator 222, at the sampling window 241. For each frame, the received signal symbols r[n′] has NM symbols, where N is the number of time slots and M is the total length of the symbol sequence and pilot signal per time slot.

The sampling window 241 performs the first step of method 800, namely step 810 of generating a plurality of sampling windows. Each sampling window has a window size of NM (which is the size of a frame) that corresponds to NM symbols. The maximum number of window position is NM, which corresponds to the number of discrete symbols in a frame.

Each sampling window is identified by an index d. Accordingly, index d=1 indicates the first sampling window, index d=2 indicates the second sampling window, and so on. Further, to indicate the symbol position within each time slot of the window, position index p is used to indicate the symbol index within each time slot.

As discussed above, a sampling window is offset by one sampling position from the immediately preceding sampling window. For example, a sampling window with index d=2 is shifted by 1 sampling position (i.e., 1 discrete symbol in the sampled sequence r [n′]) from a sampling window with index d=1. Method 800 then proceeds from step 810 to step 820.

In step 820, the sampling window 241 obtains a sequence of samples rₚ^{d}[n] using the plurality of sampling windows, where 0≤p≤ M−1, n=0,1,2, . . . , N−1, where n is the index of the time slot for a sampling window of index d, where d≥1. The sampling window 241 then obtains the sequence of samples rₚ^{d}[n]:

$${r}_{p}^{d} [ n ] = r [ d + p + n * M ] .$$

Therefore, the sequence of samples rₚ^{d}[n] relate to the plurality of sampling windows used. Method 800 proceeds from step 820 to step 830.

The sequence of samples rₚ^{d}[n] is then provided to the discrete Zak Transform 242. In step 830, Zak transform 242 generates the output sequence Rₚ^{d}[\hat{n}]:

$${R}_{p}^{d} [ n ] = {\sum }_{n = 0}^{N / q - 1} {r}_{p}^{d} [ nq ] {e}^{- j 2 π \frac{\hat{n}}{N / q} n} , \hat{n} = 0 , 1 , … , N / q - 1$$

The output sequence Rₚ^{d}[\hat{n}] is then provided to the correlator 245. Method 800 proceeds from step 830 to step 840. Step 840 is performed by the correlator 245.

Before discussing the correlator 245, the training sequence generator 243 is described. The training sequence generator 243 generates a sequence of pilot symbols {T[n]}. The sequence of pilot symbols {T[n]} provides a reference to enable the distinct frames in the received sampled sequence rₚ^{d}[n] to be identified. As discussed above in relation to the pilot and data multiplexer 214, the pilot symbol sequence {T[n]} can be any one of the well-defined pilot sequences (e.g., Zadoff-Chu sequence, Frank sequence, etc.) or the corresponding IDFT version of a pilot sequences {T[n]}.

If, at the transmitter 210, the pilot symbol is chosen from the IDFT of a pilot sequence {T[n]}, the pilot sequence {T[n]} is directly fed into the correlator 245. The reference sequence {T[k′]} is therefore equal to the pilot sequence {T[n]} selected at the pilot and data multiplexer 214.

Alternatively, if, at the transmitter 210, the pilot symbol is directly chosen from a pilot sequence {T[n]}, a discrete Fourier transform (DFT) is applied to the pilot sequence and the transformed pilot sequence is then provided to the correlator 245. In this case, the reference sequence {T[k′]} is equal to the DFT of the pilot sequence {T[n]}.

Further, the sequence of pilot symbols {T[n]} generated by the training sequence generator 243 is dependent on the implementations of the pilot symbol insertion. If the first pilot symbol insertion is implemented (i.e., when q=1) and a pilot symbol is inserted into each time slot, then the sequence of pilot symbols {T[n]} generated is also aligned at every time slot. Otherwise, if the second pilot symbol insertion is when q is other than 1 (i.e., q=2 to N/2) and a pilot symbol is inserted into every 2, 3, or more time slots, then the sequence of pilot symbols {T[n]} generated is also every 2, 3, or more time slots.

The correlator 245 receives the output sequence Rₚ^{d}[n] from the discrete Zak transform 242 and the reference sequence {Z[k′]} from the training sequence generator 243. In step 840, the correlator 245 computes the cyclic cross correlation W^{d}[q′] between the output sequence Rₚ^{d}[\hat{n}] and the frequency domain of the training sequence {Z[k′]}. The cyclic cross correlation W^{d}[q′] is given by:

$${W}^{d} [ {q}^{′} ] = {\sum }_{{k}^{′}} {R}_{p}^{d} [ {k}^{′} ] {Z}^{*} [ {( {k}^{′} - {q}^{′} )}_{N / q} ] , {q}^{′} = 0 , 1 , … , N / q - 1$$

where ( )* denotes complex conjugation.

Method 800 proceeds from step 840 to step 850. Step 850 is performed by the correlator 245 by determining the absolute values A_{q′}^{d} of the cyclic cross correlation W^{d}[q′]. The absolute values A_{q′}^{d} are obtained by:

$${A}_{{q}^{′}}^{d} = \vert {W}^{d} [ {q}^{′} ] \vert , {q}^{′} = 0 , 1 , … , N / q - 1.$$

The absolute value of the cyclic cross correlation A_{q′}^{d} is then provided to the sequence sorter 246. Method 800 proceeds from step 850 to step 860.

In step 860, the sequence sorter 246 receives and sorts the absolute value of the cyclic cross correlation A_{q′}^{d} in ascending order. The equation is provided by:

$${X}^{d} = \{ {A}_{0}^{d} , {A}_{1}^{d} , … , {A}_{N / q - 1}^{d} \}$$

The sorted cyclic cross correlation X^{d} is then provided to the metric calculation unit 247. Method 800 proceeds from step 860 to step 870.

In step 870, the metric calculation unit 247 determines the difference M(d) between the maximum value in the sorted cyclic cross correlation X^{d} and the average of the first

$$⌊ \frac{N}{2 q} ⌋$$

elements of the sorted cyclic cross correlation X^{d},

$$M ( d ) = {A}_{\frac{N}{q} - 1}^{d} - \frac{1}{⌊ \frac{N}{2 q} ⌋} {\sum }_{j = 0}^{⌊ \frac{N}{2 q} ⌋ - 1} {A}_{j}^{d}$$

The metric difference for each sampling window of the sampling window 241 is determined. Then the window with the largest metric difference is used.

There are other possible methods of calculating the metric M(d), such as maximum likelihood algorithm and least square algorithm.

The difference M(d) is then provided to the comparator 248. Method 800 proceeds from step 870 to step 880.

In step 880, the comparator 248 then determines the best estimate index d, relating to the sampling window with the least difference, using the equation:

\hat{d}=argmax_{d}(M(d))

The best estimate index \hat{d} is then provided to the synchronizer 249. Method 800 concludes at the conclusion of step 880.

The synchronizer 249 then selects the sampling window based on the best estimate index \hat{d}. That is, the sampling window of index d, where d=\hat{d}, is selected.

The frame synchronizer 240 then provides the selected sampling window to the Delay-Doppler Domain Channel estimator 250, so that the Delay-Doppler Domain Channel estimator 250 uses the selected sampling window with the best estimate index \hat{d} to estimate a channel gain, delay, and Doppler frequency shift of a path of the channel 130. The frame synchronizer 240 also provides the selected sampling window to the detector and demodulator 260, so that the detector and demodulator 260 can use the selected sampling window to sample the sampled sequence {r[n′]}. Such corresponds to method 700 proceeding from step 710 to step 720.

At step 720, method 700 estimates the channel gain, delay, and Doppler frequency shift of each path of the channel 130 based on the synchronized received frames. The Delay-Doppler Domain Channel estimator 250 performs step 720. The Delay-Doppler Domain Channel estimator 250 receives the sampling window with the best estimate index \hat{d} to sample the sampled sequence {r[n′]} to obtain N-sample sequences rₚ^{\hat{d}}[n]. The N-sample sequences rₚ^{\hat{d}}[n] are then provided to the subsequent components of the Delay-Doppler Domain Channel estimator 250.

The Delay-Doppler Domain Channel estimator 250 includes a normalization component and a discrete Fourier transform. The normalization component takes each one of the N-sample sequences rₚ^{\hat{d}}[n] as the input, and generates the normalized output sequence

$${\overline{r}}_{p}^{\hat{d}} [ n ] = {r}_{p}^{\hat{d}} [ n ] \frac{{t}_{n}^{*} [ F ]}{{\vert {t}_{n} [ F ] \vert}^{2}}$$

where (*) denotes complex conjugate operation and tₙ[F] is the pilot symbol in the n-th time slot.

The normalized sequence r̅ₚ^{\hat{d}}[n] is transformed using the discrete Fourier transform (DFT). This transformation is equivalent to the discrete Zak transform 242. The normalization and DFT of the N-sample sequences rₚ^{\hat{d}}[n] generates:

$${R}_{p}^{\hat{d}} [ n ] = {\sum }_{n = 0}^{N / q - 1} {\overline{r}}_{p}^{\hat{d}} [ n ] {e}^{- j 2 π \frac{\hat{n}}{N / q} n} , n = 0 , 1 , … , N / q - 1$$

The normalized and DFT of the received sampled sequence Rₚ^{\hat{d}}[\hat{n}] is then used to determine the channel gain ĥ_{p,\hat{n}}^{\hat{d}} and Doppler frequency shift index \hat{n} on each channel path with a position index p=0, 1, . . . , F−1 (the position index correlates to a delay). For each position index p and Doppler index \hat{n}, if the normalized and DFT of the received sampled sequence Rₚ^{\hat{d}}[\hat{n}] has a value above a predetermined threshold value, a channel path has delay

$${\hat{τ}}_{p} = \frac{pT}{M}$$

(in seconds) and Doppler frequency shift

$${\hat{v}}_{p} = \frac{\hat{n}}{NT}$$

(in Hz), where T is the duration of each time slot. The channel gain ĥ_{p,\hat{n}}^{\hat{d}} can be estimated as

$${\hat{h}}_{p , \hat{n}}^{\hat{d}} = \frac{{qR}_{p}^{\hat{d}} [ \hat{n} ]}{N} .$$

Hence, the output of the DD domain channel estimator 250 is a set of estimated parameters of channel gain, delay, and Doppler frequency shift (ĥₚ^{\hat{d}}, \hat{τ}ₚ, \hat{v}ₚ) for all paths. The set of estimated parameters (ĥₚ^{\hat{d}}, \hat{τ}ₚ, \hat{v}ₚ) for all paths is then provided to the detector and demodulator 260. Correspondingly, method 700 proceeds from step 720 to step 730.

In another arrangement, if the IDFT of the pilot sequence {T[n]} and its cyclic shifts T^{(s)}[n] are used in the transmission, the received sequence after the DFT is

$${R}_{p}^{\hat{d}} [ \hat{n} ] = {\sum }_{n = 0}^{N / q - 1} {r}_{p}^{\hat{d}} [ n ] {e}^{- j 2 π \frac{\hat{n}}{N / q} n} , n = 0 , 1 , … , N / q - 1 ,$$

where rₚ^{\hat{d}}[n] is the N-sample received sequence without normalization.

Define

$${R}_{p}^{\hat{d}} = [ {R}_{p}^{\hat{d}} [ 0 ] , {R}_{p}^{\hat{d}} [ 1 ] , ⋯ \text{?} q - 1 ] .$$

$$\text{?} \text{indicates text missing or illegible when filed}$$

Then the channel gain ĥ_{p,\hat{n}}^{\hat{d}} can be estimated as

$${\hat{h}}_{p , \hat{n}}^{\hat{d}} = \frac{1}{{L}_{s}} {\sum }_{l = 0}^{{L}_{s} - 1} Corr ( {R}_{l + p}^{\hat{d}} , {\hat{T}}^{( {l}^{′} )} ) [ \hat{n} ] ,$$

where Corr(a,b)[i] represents cross-correlation of vectors a and b with displacement i.

At step 730, method 700 extracts the symbol sequence {û[n]} using the estimated channel gain, delay, and the Doppler frequency shift (ĥₚ^{\hat{d}}, \hat{τ}ₚ, \hat{v}ₚ) of each path of the channel 130. The detector and demodulator 260 performs step 730. As described above, the detector and demodulator 260 receives the selected sampling window from the frame synchronizer 240 and the set of estimated parameters (ĥₚ^{\hat{d}}, \hat{τ}ₚ, \hat{v}ₚ) for all paths from the DD domain channel estimator 250. The detection process extracts the symbols sequence {û[n]} using the set of estimated parameters (ĥₚ^{\hat{d}}, \hat{τ}ₚ, \hat{v}ₚ) for each path with position index p and perform symbol detection on the sampled sequence r[n′] to obtain coded bit sequence {ĉ[n]}, which are used to perform a best estimate of the transmitted bits, or to provide tentative decisions as the input to the channel decoder 124.

In one arrangement, the detector and demodulator 260 performs a successive interference cancellation (SIC) based maximal ratio combining (MRC) detection to detect each transmitted signal x[t], where the multi-path copies of each transmitted signal x[t] are linearly combined at the receiver 220 with the coefficient determined by MRC to maximise the received signal-to-noise ratio for estimating the symbol. After detecting each symbol, its interference to other symbols can be cancelled based on the process of SIC before detecting the next symbol. In this manner, SIC combined with MRC further improves the detection performance of MRC. The detection and interference cancelation can be performed in either DD domain or time domain, or cross domains.

In another arrangement, the detector and demodulator 260 performs a SIC based minimum mean square error (MMSE) detection. In this arrangement, each transmitted symbol is detected based on the multi-path copies of the transmitted signal x[t] at the receiver 220 with the coefficient determined by linear MMSE estimation, which maximises the signal to interference and noise ratio of the received symbol. After detecting each symbol, its interference to other symbols can be cancelled based on the process of SIC before detecting the next symbol based on MMSE. The detection and interference cancelation can be performed in either DD domain or time domain, or cross domains.

The coded bit sequence {ĉ[n]} of the output of the Delay Doppler domain channel detector 230 is provided to the channel decoder 124. The channel decoder 124 receives and processes the coded bit sequences {ĉ[n]} to detect the existence of any error and produces the best possible guess of the information sequence {î [n]}. The channel decoder 124 performs error detection by using the r redundancy bits (see the discussion above relating to the channel encoder 116) and a decoding algorithm to remove errors (due to noise and distortion introduced in the channel 130). The information sequence {î[n]} is then provided to the source decoder 126. In an iterative receiver, the output of channel decoder 124 is fed back to the detector and demodulator 260 to further improve the accuracy of the demodulator output.

The source decoder 126 processes the information sequence {î[n]} to generate binary data {\hat{b}[n]}. If no further error exists, then the binary data is equated with the binary sequence (i.e., {\hat{b}[n]}={b[n]}). The transmission is then complete. However, if the error cannot be corrected, a retransmission may be required. The binary sequence {\hat{b}[n]} is then provided to the sink 128. The sink 128 is a device such as a computer to display a video (if the binary sequence {b[n]} relates to a video).

### Computer Description

FIGS. 4A and 4B depict a general-purpose computer system 1300, upon which the transmitter 210 (and its corresponding components) or the receiver 220 (and its corresponding components) described can be practiced.

As seen in FIG. 4A, the computer system 1300 includes: a computer module 1301; input devices such as a keyboard 1302, a mouse pointer device 1303, a scanner 1326, a camera 1327, and a microphone 1380; and output devices including a printer 1315, a display device 1314 and loudspeakers 1317. An external Modulator-Demodulator (Modem) transceiver device 1316 may be used by the computer module 1301 for communicating to and from a communications network 1320 via a connection 1321. The communications network 1320 may be a wide-area network (WAN), such as the Internet, a cellular telecommunications network, or a private WAN. Where the connection 1321 is a telephone line, the modem 1316 may be a traditional “dial-up” modem. Alternatively, where the connection 1321 is a high capacity (e.g., cable) connection, the modem 1316 may be a broadband modem. A wireless modem may also be used for wireless connection to the communications network 1320.

The computer module 1301 typically includes at least one processor unit 1305, and a memory unit 1306. For example, the memory unit 1306 may have semiconductor random access memory (RAM) and semiconductor read only memory (ROM). The computer module 1301 also includes a number of input/output (I/O) interfaces including: an audio-video interface 1307 that couples to the video display 1314, loudspeakers 1317 and microphone 1380; an I/O interface 1313 that couples to the keyboard 1302, mouse 1303, scanner 1326, camera 1327 and optionally a joystick or other human interface device (not illustrated); and an interface 1308 for the external modem 1316 and printer 1315. In some implementations, the modem 1316 may be incorporated within the computer module 1301, for example within the interface 1308. The computer module 1301 also has a local network interface 1311, which permits coupling of the computer system 1300 via a connection 1323 to a local-area communications network 1322, known as a Local Area Network (LAN). As illustrated in FIG. 4A, the local communications network 1322 may also couple to the wide network 1320 via a connection 1324, which would typically include a so-called “firewall” device or device of similar functionality. The local network interface 1311 may comprise an Ethernet circuit card, a Bluetooth® wireless arrangement or an IEEE 802.11 wireless arrangement; however, numerous other types of interfaces may be practiced for the interface 1311.

The I/O interfaces 1308 and 1313 may afford either or both of serial and parallel connectivity, the former typically being implemented according to the Universal Serial Bus (USB) standards and having corresponding USB connectors (not illustrated). Storage devices 1309 are provided and typically include a hard disk drive (HDD) 1310. Other storage devices such as a floppy disk drive and a magnetic tape drive (not illustrated) may also be used. An optical disk drive 1312 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1300.

The components 1305 to 1313 of the computer module 1301 typically communicate via an interconnected bus 1304 and in a manner that results in a conventional mode of operation of the computer system 1300 known to those in the relevant art. For example, the processor 1305 is coupled to the system bus 1304 using a connection 1318. Likewise, the memory 1306 and optical disk drive 1312 are coupled to the system bus 1304 by connections 1319. Examples of computers on which the described arrangements can be practised include IBM-PC's and compatibles, Sun Sparcstations, Apple Mac™ or like computer systems.

The method of signal detection performed by the Delay-Doppler Channel detector 230 and frame synchronization performed by the frame synchronizer 240 may be implemented using the computer system 1300 (when implemented as the receiver 220) wherein the processes of FIGS. 7 and 8, described above, may be implemented as one or more software application programs 1333 executable within the computer system 1300. In particular, the steps of methods 700 and 800 of FIGS. 7 and 8 are effected by instructions 1331 (see FIG. 4B) in the software 1333 that are carried out within the computer system 1300. The software instructions 1331 may be formed as one or more code modules, each for performing one or more particular tasks. The software may also be divided into two separate parts, in which a first part and the corresponding code modules performs the detection and frame synchronization methods and a second part and the corresponding code modules manage a user interface between the first part and the user. Similarly, other components (e.g., components 222, 124, 126, and 128) may be implemented using the computer system 1300 as described above.

The method performed by the pilot and data multiplexer 214 may be implemented using the computer system 1300 (when implemented as the transmitter 210) wherein the processes described above may be implemented as one or more software application programs 1333 executable within the computer system 1300. In particular, the steps of inserting pilot signals into data are effected by instructions 1331 (see FIG. 4B) in the software 1333 that are carried out within the computer system 1300. The software instructions 1331 may be formed as one or more code modules, each for performing one or more particular tasks. The software may also be divided into two separate parts, in which a first part and the corresponding code modules performs the detection and frame synchronization methods and a second part and the corresponding code modules manage a user interface between the first part and the user. Similarly, other components (e.g., components 112, 114, 116, 212, 214, and 118) may be implemented using the computer system 1300 as described above.

The software may be stored in a computer readable medium, including the storage devices described below, for example. The software is loaded into the computer system 1300 from the computer readable medium, and then executed by the computer system 1300. A computer readable medium having such software or computer program recorded on the computer readable medium is a computer program product. The use of the computer program product in the computer system 1300 (either implemented as the transmitter 210 or the receiver 220) preferably effects an advantageous apparatus for wireless communication.

The software 1333 is typically stored in the HDD 1310 or the memory 1306. The software is loaded into the computer system 1300 from a computer readable medium, and executed by the computer system 1300. Thus, for example, the software 1333 may be stored on an optically readable disk storage medium (e.g., CD-ROM) 1325 that is read by the optical disk drive 1312. A computer readable medium having such software or computer program recorded on it is a computer program product. The use of the computer program product in the computer system 1300 (either implemented as the transmitter 210 or the receiver 220) preferably effects an apparatus for wireless communication.

In some instances, the application programs 1333 may be supplied to the user encoded on one or more CD-ROMs 1325 and read via the corresponding drive 1312, or alternatively may be read by the user from the networks 1320 or 1322. Still further, the software can also be loaded into the computer system 1300 from other computer readable media. Computer readable storage media refers to any non-transitory tangible storage medium that provides recorded instructions and/or data to the computer system 1300 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 1301. Examples of transitory or non-tangible computer readable transmission media that may also participate in the provision of software, application programs, instructions and/or data to the computer module 1301 include radio or infra-red transmission channels as well as a network connection to another computer or networked device, and the Internet or Intranets including e-mail transmissions and information recorded on Websites and the like.

The second part of the application programs 1333 and the corresponding code modules mentioned above may be executed to implement one or more graphical user interfaces (GUIs) to be rendered or otherwise represented upon the display 1314. Through manipulation of typically the keyboard 1302 and the mouse 1303, a user of the computer system 1300 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1317 and user voice commands input via the microphone 1380.

FIG. 4B is a detailed schematic block diagram of the processor 1305 and a “memory” 1334. The memory 1334 represents a logical aggregation of all the memory modules (including the HDD 1309 and semiconductor memory 1306) that can be accessed by the computer module 1301 in FIG. 4A.

When the computer module 1301 is initially powered up, a power-on self-test (POST) program 1350 executes. The POST program 1350 is typically stored in a ROM 1349 of the semiconductor memory 1306 of FIG. 4A. A hardware device such as the ROM 1349 storing software is sometimes referred to as firmware. The POST program 1350 examines hardware within the computer module 1301 to ensure proper functioning and typically checks the processor 1305, the memory 1334 (1309, 1306), and a basic input-output systems software (BIOS) module 1351, also typically stored in the ROM 1349, for correct operation. Once the POST program 1350 has run successfully, the BIOS 1351 activates the hard disk drive 1310 of FIG. 4A. Activation of the hard disk drive 1310 causes a bootstrap loader program 1352 that is resident on the hard disk drive 1310 to execute via the processor 1305. This loads an operating system 1353 into the RAM memory 1306, upon which the operating system 1353 commences operation. The operating system 1353 is a system level application, executable by the processor 1305, to fulfil various high level functions, including processor management, memory management, device management, storage management, software application interface, and generic user interface.

The operating system 1353 manages the memory 1334 (1309, 1306) to ensure that each process or application running on the computer module 1301 has sufficient memory in which to execute without colliding with memory allocated to another process. Furthermore, the different types of memory available in the system 1300 of FIG. 4A must be used properly so that each process can run effectively. Accordingly, the aggregated memory 1334 is not intended to illustrate how particular segments of memory are allocated (unless otherwise stated), but rather to provide a general view of the memory accessible by the computer system 1300 and how such is used.

As shown in FIG. 4B, the processor 1305 includes a number of functional modules including a control unit 1339, an arithmetic logic unit (ALU) 1340, and a local or internal memory 1348, sometimes called a cache memory. The cache memory 1348 typically includes a number of storage registers 1344-1346 in a register section. One or more internal busses 1341 functionally interconnect these functional modules. The processor 1305 typically also has one or more interfaces 1342 for communicating with external devices via the system bus 1304, using a connection 1318. The memory 1334 is coupled to the bus 1304 using a connection 1319.

The application program 1333 includes a sequence of instructions 1331 that may include conditional branch and loop instructions. The program 1333 may also include data 1332 which is used in execution of the program 1333. The instructions 1331 and the data 1332 are stored in memory locations 1328, 1329, 1330 and 1335, 1336, 1337, respectively. Depending upon the relative size of the instructions 1331 and the memory locations 1328-1330, a particular instruction may be stored in a single memory location as depicted by the instruction shown in the memory location 1330. Alternately, an instruction may be segmented into a number of parts each of which is stored in a separate memory location, as depicted by the instruction segments shown in the memory locations 1328 and 1329.

In general, the processor 1305 is given a set of instructions which are executed therein. The processor 1305 waits for a subsequent input, to which the processor 1305 reacts to by executing another set of instructions. Each input may be provided from one or more of a number of sources, including data generated by one or more of the input devices 1302, 1303, data received from an external source across one of the networks 1320, 1302, data retrieved from one of the storage devices 1306, 1309 or data retrieved from a storage medium 1325 inserted into the corresponding reader 1312, all depicted in FIG. 4A. The execution of a set of the instructions may in some cases result in output of data. Execution may also involve storing data or variables to the memory 1334.

The disclosed arrangements use input variables 1354, which are stored in the memory 1334 in corresponding memory locations 1355, 1356, 1357. The disclosed arrangements produce output variables 1361, which are stored in the memory 1334 in corresponding memory locations 1362, 1363, 1364. Intermediate variables 1358 may be stored in memory locations 1359, 1360, 1366 and 1367.

Referring to the processor 1305 of FIG. 4B, the registers 1344, 1345, 1346, the arithmetic logic unit (ALU) 1340, and the control unit 1339 work together to perform sequences of micro-operations needed to perform “fetch, decode, and execute” cycles for every instruction in the instruction set making up the program 1333. Each fetch, decode, and execute cycle comprises:
a fetch operation, which fetches or reads an instruction 1331 from a memory location 1328, 1329, 1330;
a decode operation in which the control unit 1339 determines which instruction has been fetched; and
an execute operation in which the control unit 1339 and/or the ALU 1340 execute the instruction.

Thereafter, a further fetch, decode, and execute cycle for the next instruction may be executed. Similarly, a store cycle may be performed by which the control unit 1339 stores or writes a value to a memory location 1332.

Each step or sub-process in the processes of FIGS. 7 and 8 (or the pilot insertion method) is associated with one or more segments of the program 1333 and is performed by the register section 1344, 1345, 1347, the ALU 1340, and the control unit 1339 in the processor 1305 working together to perform the fetch, decode, and execute cycles for every instruction in the instruction set for the noted segments of the program 1333.

The methods performed by the transmitter 210 or the receiver 220 may alternatively be implemented in dedicated hardware such as one or more integrated circuits performing the functions or sub functions described above, in particular the functions or sub functions of FIGS. 7 and 8. Such dedicated hardware may include graphic processors, digital signal processors, FPGA and ASCI chipsets, or one or more microprocessors and associated memories.

### INDUSTRIAL APPLICABILITY

In recent years, the reuse of communication systems for radar sensing is of particular interest in the case of vehicle-to-vehicle (V2V) communication scenarios, especially for the evolution of autonomous vehicles. The most important aspect in a joint communication-radar system is the design of a waveform, transmitter, and common receiver that is capable of handling both radar and communication functions simultaneously. In radar systems, the waveform is mainly characterized by an ambiguity function, which determines the range and velocity resolution of the radar, which can be inferred as the delay and Doppler of the propagation signal, respectively. The duration of radar pulse determines the accuracy of the Doppler estimation. On the contrary, communication waveform is designed by embedding and transmitting information to a user, which includes components for symbol and frame synchronizations, channel estimation and frequency offset estimation.

The above described transmitter 210 and receiver 220 enable a more accurate detection of the transmitted data by using the Delay Doppler domain channel estimation. Although the transmitter 210 and receiver 220 are described above in relation to wireless communication, the transmitter 210 and receiver 220 can also be used for joint communication-radar systems, radar systems or acoustic sensing systems. To be able to perform detection and equalization in any of the signal domains, the characteristic of channel needs to be obtained by performing channel estimation. As described above, a signal can be represented in a 2D function of both time (delay) and frequency (Doppler) domains. Since the doubly dispersive channels have both delay and Doppler impairments, it is desirable to perform channel estimation in a 2D representation of a signal to have a simple yet accurate channel estimation.

The arrangements described are therefore applicable to the wireless communication and radar industry.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A wireless receiver comprising:
a Delay Doppler channel detector comprising:
a Delay Doppler domain channel estimator configured for estimating a channel gain, a delay, and a Doppler frequency shift of a path of a channel of data received via the channel; and
a detector and demodulator configured for extracting a symbol sequence of the received data based on the estimated channel gain, the estimated delay, and the estimated Doppler frequency shift of the path of the channel that was estimated.

2. The wireless receiver of claim 1, wherein the Delay Doppler channel detector further comprises:
a frame synchronizer configured for determining a sampling window for sampling the received data,
wherein the sampling window is aligned to a starting position of a frame of the received data
wherein the Delay Doppler domain channel estimator is configured for sampling the received data using the sampling window, and
wherein the estimated channel gain, the estimated delay, and the estimated Doppler frequency shift are based on the received data sampled by the sampling window.

3. The wireless receiver of claim 2, wherein the frame synchronizer is further configured for operations comprising:
generating a plurality of sampling windows, wherein a second sampling window is offset by a sampling position from a first sampling window preceding the second sampling window;
obtaining a sequence of samples using the plurality of sampling windows;
comparing the sequence of samples against a reference sequence of pilot symbols, wherein the reference sequence of pilot symbols corresponds to a sequence of pilot symbol in the receiver; and
determining a metric difference for each of the plurality of sampling windows,
wherein the sampling window of the plurality of sampling windows is selected based on the determined metric difference, and
wherein the selected sampling window is used to sample the received data.

4. The wireless receiver of claim 3, wherein the sequence of pilot symbols is selected from any one of a Zadoff-Chu sequence, a Frank sequence, a Golay complementary sequence, a Barker sequence, Gold sequence, Hadamard sequence, Legendre sequence and Maximum length sequence (M-sequence), JPL sequence, Kasami sequence, polyphase sequence, or general complementary sequence; or an Inverse Discrete Fourier Transform of any one of a Zadoff-Chu sequence, a Frank sequence, a Golay complementary sequence, a Barker sequence, Gold sequence, Hadamard sequence, Legendre sequence and Maximum length sequence (M-sequence), JPL sequence, Kasami sequence, polyphase sequence, and or general complementary sequence.

5. The wireless receiver of claim 3, wherein a prefix zero padded sequence, a pilot symbol of the sequence of pilot symbols, and a suffix zero padded sequence are inserted into a time slot of the frame.

6. The wireless receiver of claim 5, wherein one or more time slots of the frame does not have a pilot symbol of the sequence of pilot symbols.

7. The wireless receiver of claim 5, wherein an additional pilot symbol is inserted into the time slot of the frame, and
wherein the additional pilot symbol is a cyclic shift of the sequence of pilot symbols.

8. The wireless receiver of claim 3, wherein the frame synchronizer is further configured for operations comprising:
computing a cyclic cross correlation between the sequence of samples and the reference sequence of pilot symbols when comparing the sequence of samples against the reference sequence of pilot symbols;
determining absolute values of the cyclic cross correlation; and
sorting the absolute values in ascending order,
wherein the metric difference is determined based on the sorted absolute values.

9. A method of receiving wireless communication, the method comprising:
estimating a channel gain, a delay, and a Doppler frequency shift of a path of a channel of data received via the channel; and
extracting a symbol sequence of the received data based on the estimated channel gain, the estimated delay, and the estimated Doppler frequency shift of the path of the channel.

10. The method of claim 9, further comprising:
determining a sampling window for sampling the received data, wherein the sampling window is aligned to a starting position of a frame of the received data; and
sampling the received data using the sampling window,
wherein the estimated channel gain, the estimated delay, and the estimated Doppler frequency shift are based on the received data sampled by the sampling window.

11. The method of claim 10, further comprising:
generating a plurality of sampling windows, wherein a second sampling window is offset by a sampling position from a first sampling window preceding the second sampling window;
obtaining a sequence of samples using the plurality of sampling windows;
comparing the sequence of samples against a reference sequence of pilot symbols, wherein the reference sequence of pilot symbols corresponds to a sequence of pilot symbol in the wireless receiver; and
determining a metric difference for each of the plurality of sampling windows,
wherein the sampling window of the plurality of sampling windows is selected based on the determined metric difference, and
wherein the selected sampling window is used to sample the received data.

12. The method of claim 11, wherein the sequence of pilot symbols is selected from any one of a Zadoff-Chu sequence, a Frank sequence, a Golay complementary sequence, a Barker sequence, Gold sequence, Hadamard sequence, Legendre sequence and Maximum length sequence (M-sequence), JPL sequence, Kasami sequence, polyphase sequence, or general complementary sequence; or an Inverse Discrete Fourier Transform of any one of a Zadoff-Chu sequence, a Frank sequence, a Golay complementary sequence, a Barker sequence, Gold sequence, Hadamard sequence, Legendre sequence and Maximum length sequence (M-sequence), JPL sequence, Kasami sequence, polyphase sequence, or general complementary sequence.

13. The method of claim 11, wherein a prefix zero padded sequence, a pilot symbol of the sequence of pilot symbols, and a suffix zero padded sequence are inserted into a time slot of the frame.

14. The method of claim 13, wherein one or more time slots of the frame does not have a pilot symbol of the sequence of pilot symbols.

15. The method of claim 13, wherein an additional pilot symbol is inserted into the time slot of the frame, and
wherein the additional pilot symbol is a cyclic shift of the sequence of pilot symbols.

16. The method of claim 11, the method further comprising:
computing a cyclic cross correlation between the sequence of samples and the reference sequence of pilot symbols when comparing the sequence of samples against the reference sequence of pilot symbols;
determining absolute values of the cyclic cross correlation; and
sorting the absolute values in ascending order,
wherein the metric difference is determined based on the sorted absolute values.

17. A computer program product comprising a computer readable medium having recorded thereon a computer program of a method of receiving wireless communication, wherein the computer program is executable by a processor to perform operations comprising:
estimating a channel gain, a delay, and a Doppler frequency shift of a path of a channel of data received via the channel; and
extracting a symbol sequence of the received data based on the estimated channel gain, the estimated delay, and the estimated Doppler frequency shift of the path of the channel.

18. The computer program product of claim 17, wherein the processor is further configured to perform operations comprising:
determining a sampling window for sampling the received data, wherein the sampling window is aligned to a starting position of a frame of the received data; and
sampling the received data using the sampling window, wherein the estimated channel gain, the estimated delay, and the estimated Doppler frequency shift are based on the received data sampled by the sampling window.

19. The computer program product of claim 18, wherein the processor is further configured to perform operations comprising:
generating a plurality of sampling windows, wherein a second sampling window is offset by a sampling position from a first sampling window preceding the second sampling window;
obtaining a sequence of samples using the plurality of sampling windows;
comparing the sequence of samples against a reference sequence of pilot symbols, wherein the reference sequence of pilot symbols corresponds to a sequence of pilot symbol in the wireless receiver; and
determining a metric difference for each of the plurality of sampling windows, wherein the sampling window of the plurality of sampling windows is selected based on the determined metric difference, and wherein the selected sampling window is used to sample the received data.

20. The computer program product of claim 19, wherein the sequence of pilot symbols is selected from any one of a Zadoff-Chu sequence, a Frank sequence, a Golay complementary sequence, a Barker sequence, Gold sequence, Hadamard sequence, Legendre sequence and Maximum length sequence (M-sequence), JPL sequence, Kasami sequence, polyphase sequence, or general complementary sequence; or an Inverse Discrete Fourier Transform of any one of a Zadoff-Chu sequence, a Frank sequence, a Golay complementary sequence, a Barker sequence, Gold sequence, Hadamard sequence, Legendre sequence and Maximum length sequence (M-sequence), JPL sequence, Kasami sequence, polyphase sequence, or general complementary sequence.

21. The computer program product of claim 20, wherein a prefix zero padded sequence, a pilot symbol of the sequence of pilot symbols, and a suffix zero padded sequence are inserted into a time slot of the frame.

22. The computer program product of claim 21, wherein one or more time slots of the frame does not have a pilot symbol of the sequence of pilot symbols.

23. The computer program product of claim 21, wherein an additional pilot symbol is inserted into the time slot of the frame, and
wherein the additional pilot symbol is a cyclic shift of the sequence of pilot symbols.

24. The computer program product of claim 19, wherein the processor is further configured to perform operations comprising:
computing a cyclic cross correlation between the sequence of samples and the reference sequence of pilot symbols when comparing the sequence of samples against the reference sequence of pilot symbols;
determining absolute values of the cyclic cross correlation; and
sorting the absolute values in ascending order,
wherein the metric difference is determined based on the sorted absolute values.

25. A wireless transmitter comprising:
a pilot and data multiplexer configured for inserting a prefix zero padded sequence, a pilot symbol of a sequence of pilot symbols, and a suffix zero padded sequence into a time slot of a frame of data to be transmitted.

26. The wireless transmitter of claim 25, wherein one or more time slots of the frame does not have a pilot symbol of the sequence of pilot symbols.

27. The wireless transmitter of claim 25, wherein an additional pilot symbol is inserted into the time slot of the frame, and
wherein the additional pilot symbol is a cyclic shift of the sequence of pilot symbols.
